(19) United States
(12) Patent Application Publication
(10) Pub. No.: US 2012/0124396 A1
(43) Pub. Date: May 17, 2012

(54) COMPUTER SERVER

(75) Inventors: ZHENG-HENG SUN, Tu-Cheng (TW); MING-KE CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/965,907

(22) Filed: Dec. 12, 2010

(30) Foreign Application Priority Data
Nov. 17, 2010 (CN) 201010547930.0

(51) Int. Cl. G06F 1/26

(52) U.S. Cl. 713/300

(57) ABSTRACT

A server includes a power line assembly, at least one hard disc drive (HDD), at least one fixing base, and a power supply module. Each HDD defines a power interface. Each fixing base defines a slot. The structure of the slot is substantially the same as that of the power interface. The power supply module is used for supplying power to the at least one HDD. The power line includes a main plug and at least two sub-plugs. The main plug is plugged into the power supply module. One of the at least two sub-plugs is plugged into the power interface of one of the at least one HDD, and another one of the at least two sub-plugs is plugged into the slot of one of the at least one fixing base.

### BACKGROUND

1. Technical Field

The present disclosure relates to a computer server.

2. Description of Related Art

Computer servers generally include a plurality of hard disk drives (HDDs). To conveniently manage the power lines connecting the HDDs to a power supply module, the computer server employs a main power line with one end connecting to the power supply module and the other end having a plurality of sub-plugs connected to the respective HDDs. However, if any one or more of the sub-plugs is not used it will be free to move around and possibly damage other electrical elements.

Therefore, it is desirable to provide a computer server that can overcome the above-mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a computer server according to one embodiment.

FIG. 2 is an exploded view of the computer server of FIG. 1.

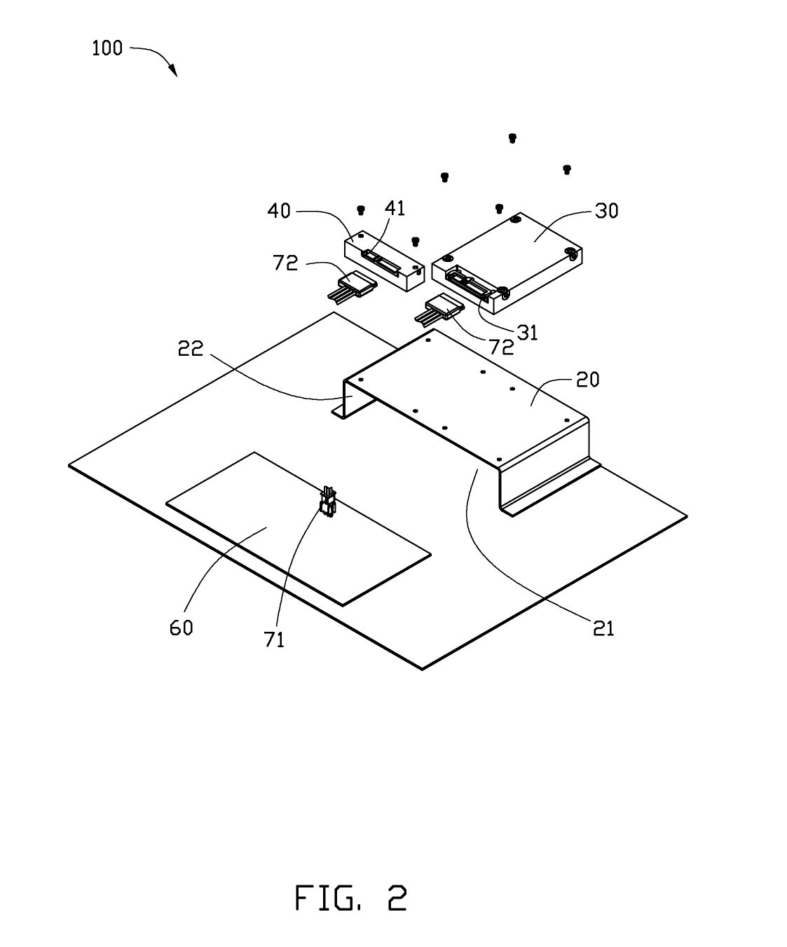

### DETAILED DESCRIPTION

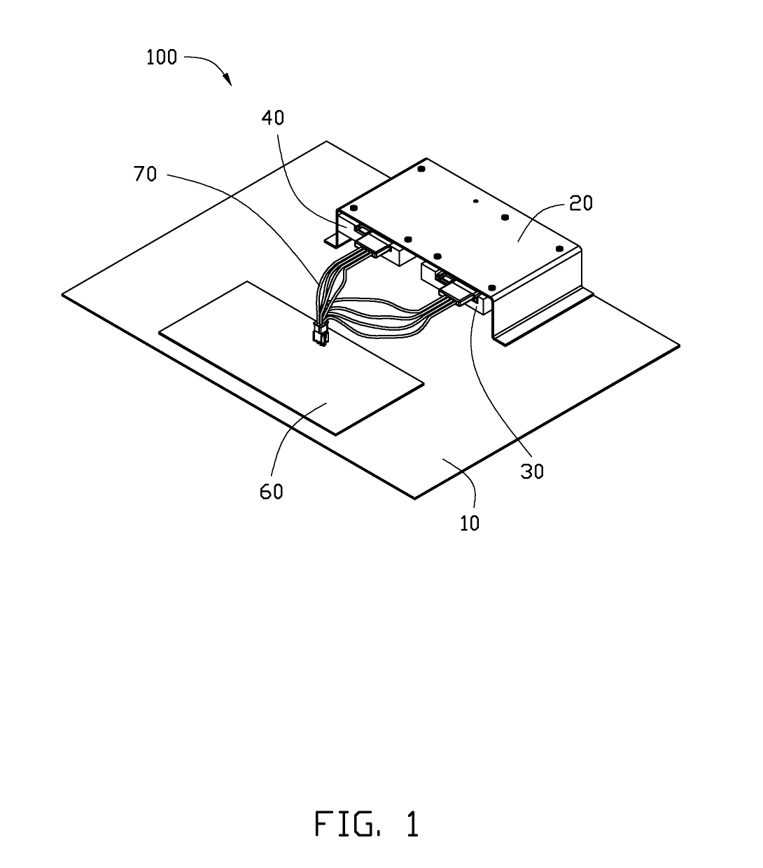

Referring to FIGS. 1&2, one embodiment of a computer server 100 includes a motherboard 10, a shielding cover 20, a HDD 30, a fixing base 40, a power supply module 60, and a power line assembly 70. The shielding cover 20 and the power supply module 60 are fixed on the motherboard 10. The HDD 30 and the fixing base 40 are positioned on the shielding cover 20.

The shielding cover 20 is used for protecting the HDD 30 and defines a receiving groove 21 having an opening 22.

The HDD 30 and the fixing base 40 are received in the receiving groove 21. The HDD 30 has a power interface 31. The fixing base 40 defines a slot 41. The structure of the slot 41 is substantially identical to that of the power interface 31. Both the power interface 31 and the slot 41 face the opening 22. In this embodiment, the fixing base 40 is made of plastic material.

The power supply module 60 is disposed opposite to the opening 22 and used for supplying power to the HDD 30.

The power line assembly 70 includes a main plug 71 and two sub-plugs 72. The main plug 71 is plugged into the power supply module 60. The two sub-plugs 72 are respectively plugged into the power interface 31 and the slot 41. Thus, both the sub-plugs 72 are fixed even though one is not used. The number of the sub-plugs 72 is equal to the total number of the power interface 31 and the slot 41.

In this embodiment, the fixing base 40 is located where a dismantled HDD was or would be located. In other embodiments, the fixing base 40 can be disposed on other positions of the motherboard 10.

The number of the HDD 30 and the fixing base 40 are not limited to this embodiment. In other embodiments, more than one (e.g. two or three) HDD 30 and fixing base 40 may be employed according to need.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A computer server comprising:
at least one hard disc drive (HDD), each HDD defining a power interface;
at least one fixing base, each fixing base defining a slot, wherein the structure of the slot is substantially identical to that of the power interface;
a power supply module configured for supplying power to the at least one HDD; and
a power line assembly electrically connected between the power supply module and the at least one HDD, the power line assembly comprising a main plug electrically plugged into the power supply module and at least two sub-plugs, wherein one of the at least two sub-plugs is plugged into the power interface of one of the at least one HDD, another one of the at least two sub-plugs is plugged into the slot of one of the at least one fixing base.

2. The computer server in claim 1, wherein the power interface faces the power supply module.

3. The computer server in claim 1, wherein the slot faces the power supply module.

4. The computer server in claim 1, wherein the computer server further comprises a motherboard and a shielding cover, the power supply module and the shielding cover are positioned on the motherboard, the at least one HDD and the at least one fixing base are covered by the shielding cover.

5. The computer server in claim 4, wherein the shielding cover has an opening facing to the power supply module, the power interface faces to the opening.

6. The computer server in claim 5, wherein the at least one HDD and the at least one fixing base are positioned on the shielding cover, and the slot faces to the opening.

7. The computer server in claim 1, wherein the at least one fixing base is made of plastic material.

8. The computer server in claim 1, wherein the number of the at least two sub-plugs is equal to the total number of the at least one HDD and the at least one fixing base.
